(19) United States
(12) Patent Application Publication
(10) Pub. No.: US 2012/0177969 A1
(43) Pub. Date: Jul. 12, 2012

(54) Battery module

(76) Inventor: Hee-Joon Jin, Yongin-si (KR)

(21) Appl. No.: 13/200,935

(22) Filed: Oct. 5, 2011

(30) Foreign Application Priority Data
Jan. 12, 2011 (KR) 10-2011-0003111

(51) Int. Cl. H01M 10/02; H01M 10/50

(52) U.S. Cl. 429/120; 429/157

(57) ABSTRACT

A battery module includes a plurality of battery cells aligned in one direction. First and second end plates are disposed outside of end ones of the battery cells, respectively. One or more connection members connect the first and second end plates to each other. In the battery module, one or more first alignment portions are provided on at least one side of the first and second end plates, and one or more second alignment portions corresponding to the one or more first alignment portions are provided to the connection member. Accordingly, it is possible to provide a battery module having enhanced reliability by improving the accuracy of assembling of battery cells members that constitute the battery module.

### BACKGROUND

1. Field

Embodiments described herein relate to a battery module, and more particularly, to a battery module capable of enhancing productivity and reliability by improving a structure for fixing a plurality of battery cells.

2. Description of the Related Art

Recently, a high-power battery module using a non-aqueous electrolyte with high-energy density has been developed. The high-power battery module is configured as a large-capacity battery module manufactured by connecting a plurality of battery cells in series so as to be used in driving motors of devices requiring high power, e.g., electric vehicles and the like.

### SUMMARY

According to an embodiment, there is provided a battery module including a plurality of battery cells aligned in one direction, first and second end plates respectively disposed outside of end ones of the battery cells, and one or more connection members that connect the first and second end plates to each other, one or more first alignment portions on at least one side of the first and second end plates, and one or more second alignment portions corresponding to the one or more first alignment portions on the one or more the connection members.

The battery module may further include at least one fixing portion in cooperation with the first and second alignment portions. The fixing portion may be connected to the first or second end plate and a first or second end of a connection member of the one or more connection members.

The fixing portion may include a first through-hole through the first or second end plate, and a second through-hole through the first or second end of the connection member so as to correspond to the first through-hole.

The first and second through-holes may align with each other so as to be penetrated by a fixing member.

The fixing member may include a bolt or stud.

The first or second end plate may include a base plate disposed parallel to the battery cells and one or more flange portions at side ends of the base plate. The one or more flange portions may be bent in an opposite direction with respect to the battery cells.

At least a portion of the flange portion may contact the first or second end of a connection member of the one or more connection members.

The flange portion may include the one or more first alignment portions. The first or second end of the connection member may include the one or more second alignment portions that correspond to the one or more first alignment portions.

The flange portion may be wider than the first or second end of the connection member coupled to the flange portion.

The second alignment portion may be provided at a side end of the first or second end of the connection member at a position corresponding to the first alignment portion.

The first alignment portion may be parallel to a length direction of the battery cells. The second alignment portion may extend in a straight line with respect to the first alignment portion.

The first alignment portion may include a vertical portion that is parallel to the battery cells in the length direction of the battery cells and a horizontal portion that intersects the vertical portion. The second alignment portion may extend in a straight line with respect to the vertical portion.

The horizontal portion of the first alignment portion may vertically intersect with the vertical portion so as to correspond to a side end of the connection member.

The flange portion may include two first through-holes. The first or second end of the connection member may include two second through-holes that respectively correspond to the two first through holes. The first and second through-holes may be coupled by a fixing member.

The one or more first alignment portions may include a cross-shaped first alignment portion on the flange portion and between the two second through-holes. The one or more second alignment portions may include a hole in the first or second end of the connection member such that a cross-shaped center of the first alignment portion is exposed and line shapes that respectively extend in a straight line with respect to each end of the cross-shaped center exposed through the hole.

The first or second alignment portion may be provided using a laser or by punching.

The one or more connection members may include side plates that support sides of the battery cells and a bottom plate that supports bottom surfaces of the battery cells.

The side plate may include side plate holes through which a coolant for cooling the plurality of battery cells passes.

### BRIEF DESCRIPTION OF THE DRAWINGS

The above and other features will become more apparent to those of ordinary skill in the art by describing in detail exemplary embodiments with reference to the attached drawings, in which:

FIG. 1 illustrates a perspective view of a battery module according to an embodiment.

FIG. 2 illustrates an exploded perspective view of FIG. 1.

FIG. 3A illustrates an exploded perspective view of a fixing portion of a first end plate and a side plate according to the embodiment.

FIG. 3B illustrates a side view of portion X of FIG. 1.

FIG. 4A illustrates an exploded perspective view of a fixing portion of a first end plate and a side plate according to another embodiment.

FIG. 4B illustrates a side view showing a state that the side plate is fixed to the first end plate.

FIG. 5A illustrates an exploded perspective view of a fixing portion of a first end plate and a side plate according to still another embodiment.

FIG. 5B illustrates a side view showing a state that the side plate is fixed to the first end plate.

### DETAILED DESCRIPTION

Korean Patent Application No. 10-2011-0003111, filed on Jan. 12, 2011, in the Korean Intellectual Property Office, and entitled: “Battery Module” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

Hereinafter, exemplary embodiments will be described with reference to the accompanying drawings.

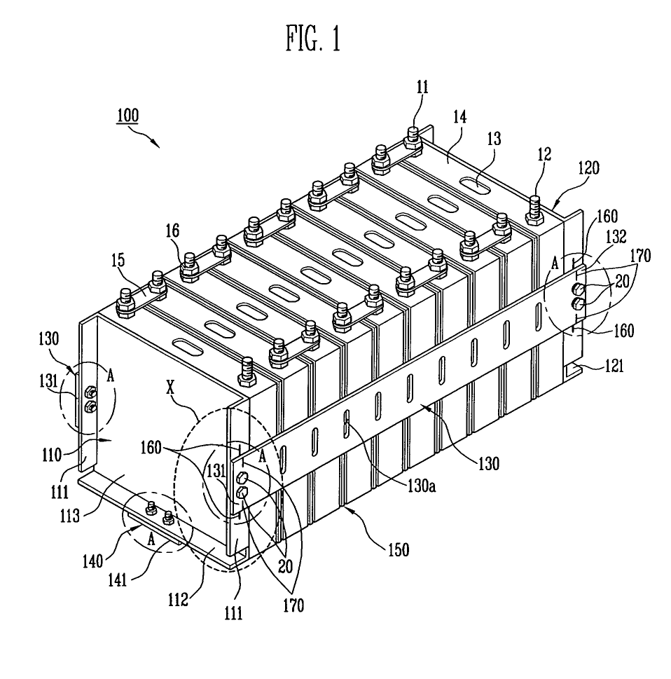

An exemplary embodiment will be described with reference to FIGS. 1 to 3B.

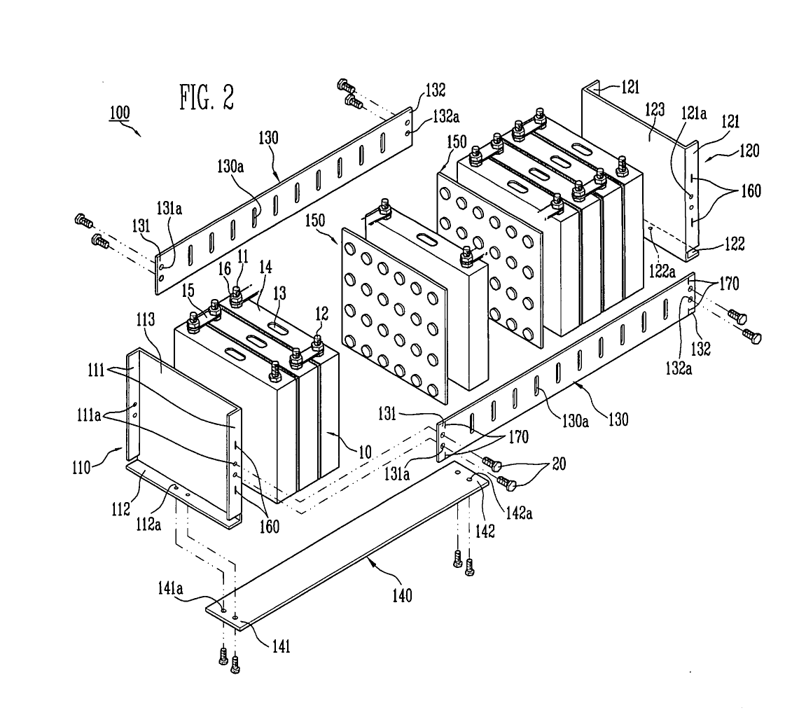

FIG. 1 is a perspective view of a battery module according to an embodiment. FIG. 2 is an exploded perspective view of FIG. 1.

The battery module 100 according to this embodiment includes a plurality of battery cells aligned in one direction; first and second end plates 110 and 120 respectively disposed at outsides of the battery cells 10; and one or more connection members 130 and 140 that connect the first and second plates 110 and 120 to each other. One or more first alignment portions 160 are provided to at least one side of the first and second end plates 110 and 120, and one or more second alignment portions 170 are provided corresponding to the one or more first alignment portions 160.

The battery cells 10 may be manufactured by accommodating an electrode assembly and an electrolyte in a battery case and then sealing the battery case with a cap plate 14. The cap plate 14 may include positive and negative electrode terminals 11 and 12 respectively provided to both ends on the cap plate 14 and a vent 13 provided between the terminals 11 and 12. The electrode assembly may include a positive electrode plate, a negative electrode plate and a separator interposed therebetween. The positive electrode plate is connected to the positive electrode terminal 11, and the negative electrode plate is connected to the negative electrode terminal 12. Thus, energy generated by an electrochemical reaction of the electrode assembly and the electrolyte is transferred to the exterior of the battery cell 10. The vent 13 serves as a passage along which gas generated in the interior of the battery cell 10 is exhausted to the exterior of the battery cell 10.

The battery module 100 has one or more fixing portion A connected to the first or second end plate 110 or 120, and first ends 131 and 141 or second ends 132 and 142 of the connection members 130 and 140. The first and second alignment portions 160 and 170 may be provided to the fixing portion A.

The pair of first and second end plates 110 and 120 and the connection members 130 and 140 that connect the first and second end plates 110 and 120 define a certain space for accommodating a plurality of battery cells 10. The battery cells 10 may be aligned in one direction within the defined space. The battery cells 10 may be aligned in parallel so that wide front surfaces of the battery cells 10 face each other. Thus, the positive and negative electrode terminals 11 and 12 of two adjacent battery cells 10 may be electrically connected through a bus-bar 15. The bus-bar 15 may be provided with holes through which the respective positive and negative electrode terminals 11 and 12 pass and the bus-bar 15 pass to be connected to each other. The respective positive and negative electrode terminals 11 and 12 pass and the bus-bar 15 may be fixed by members such as nuts.

The first and second end plates 110 and 120 may be disposed to come into surface contact with the outermost ones of the battery cells 10, respectively. The first and second end plates 110 and 120 may pressurize the plurality of battery cells 10 inwardly from the two outermost battery cells 10. In the plurality of battery cells 10 supported by the first and second end plates 110 and 120, the side plates 130 and the bottom plate 140, the positive and negative electrode terminals 11 and 12 may be alternately aligned so that the plurality of battery cells 10 can be connected in series to one another.

The connecting members 130 and 140 may include side plates 130 and a bottom plate 140. The side plates 130 may support both side surfaces of the battery cells 10, and the bottom plate may support bottom surfaces of the battery cells 10. The side plate 130 may include holes 130a through which a coolant for cooling the plurality of battery cells 10 passes. First ends 131 and 141 of the side and bottom plates 130 and 140 may be connected to the first end plate 110, and second ends 132 and 142 of the side and bottom plates 130 and 140 may be connected to the second end plate 120.

The first and second end plates 110 and 120, the side plates 130 and the bottom plate 140 may constitute a housing for stably fixing the plurality of battery cells 10. These features may be variously modified according to the design object of the battery module. The connection structure and number of the first and second end plates and side and bottom plates 110, 120, 130 and 140, and the fixing portions A that connect them, may also be variously modified.

The battery module 100 according to the present embodiment may include a fixing portion A connected to or integral with the first or second end plate 110 or 120 and first end 131 or 141 or second end 132 or 142 of the side or bottom plate 130 or 140. First and second alignment portions 160 and 170 may be provided to the fixing portion A.

The fixing portion A may be a portion at which the first or second plate 110 or 120 and the side or bottom plate 130 and 140 are connected to each other. The fixing force of the fixing portion A may be increased using welding, separate fixing members 20, or the like. The fixing portion A may include first through-holes 111a, 121a, 112a and 122a provided to the first and second end plates 110 and 120, and second through-holes 131a, 132a, 141a and 142a provided to the first and the second ends 131, 132, 141 and 142 of the side and bottom plates 130 and 140, corresponding to the first through-holes 111a, 121 a, 112a and 122a. The first and second through-holes 111a and 121a, 112a and 122a, 131a and 132a or 141a and 142a may be provided to correspond to each other, thereby forming a path along which the first and second through-holes may be penetrated by the fixing member 20.

Specifically, the electrode assembly may expand or contract when the battery cell 10 is charged or discharged. Therefore, in the battery module 100 formed by aligning the plurality of battery cells 10, the expansion and contraction of the electrode assembly may act as a force that pushes the first or second end plate 110 or 120 and the side or bottom plate 130 or 140 toward the exterior of the battery module 100. Furthermore, the external force may cause a deformation of the battery module 100. Therefore, the deformation may persist due to repeated expansion and contraction.

The volume expansion of the electrode assembly may interrupt the flow of current. The charge/discharge efficiency of the battery cell 10 may be deteriorated by an increase in the resistance of the battery cell 10. Therefore, a problem of reliability, such as a reduction of the battery lifetime, may be caused. In order to address such a problem, the first and second end plates 110 and 120 and the side and bottom plates 130 and 140 can compress and fix the plurality of battery cells 10 so that the plurality of battery cells 10 are no longer extended in a horizontal direction by the expansion and contraction.

The first and second end plates 110 and 120 may include base plates 113 and 123 disposed parallel to the battery cells 10, and one or more flange portions 111, 112, 121 and 122 at side ends of the base plates 113 and 123, the one or more flange portions 111, 112, 121 and 122 being bent in an opposite direction with respect to the battery cells 10.

The base plates 113 and 123 may have a size that covers the exterior of the end ones of the battery cells 10. In this embodiment, the base plates 113 and 123 may be formed in the shape of an approximately square or rectangular, corresponding to the shape of the battery cell 10. However, the present invention is not limited thereto.

The flange portions 111, 112, 121 and 122 may include side flange portions 111 and 121 and bottom flange portions 112 and 122. The flange portions 111, 112, 121 and 122 may be provided so that at least a portion of each of the flange portions 111, 112, 121 and 122 comes in contact with the first or the second end 131, 141, 132 or 142 of the side or bottom plate 130 or 140. In this instance, the side flange portions 111 and 121 may be fixedly coupled to the side plates 130, and the bottom flange portions 112 and 122 may be fixedly coupled to the bottom plate 140.

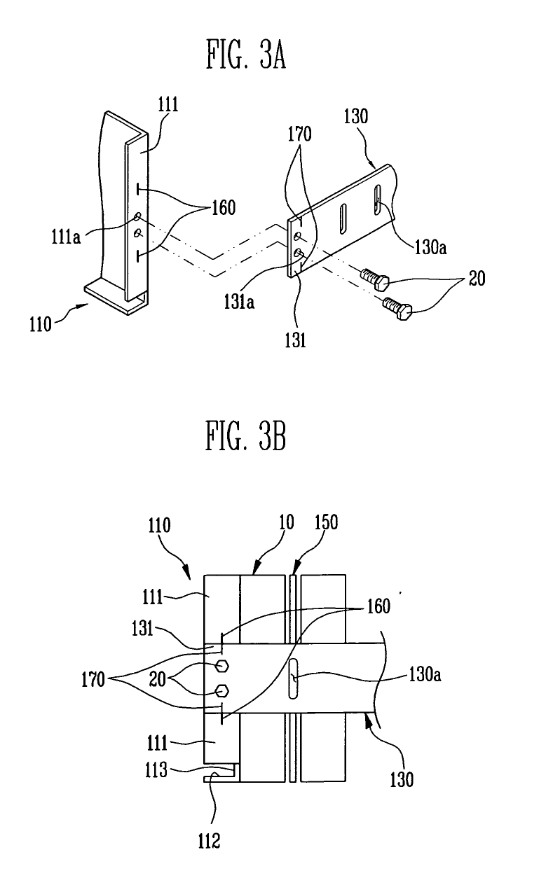

FIG. 3A is an exploded perspective view of a fixing portion of a first end plate and a side plate according to the embodiment. FIG. 3B is a side view of portion X of FIG. 1.

The fixing portion A (see FIG. 1) of the battery module 100 according to this embodiment will be described with reference to FIGS. 3A and 3B.

In the battery module 100 according to this embodiment, the flange portion 111 may include one or more first alignment portions 160, and the first end 131 or the other second of the side plate 130 may include one or more second alignment portions 170 that correspond to the first alignment portion 160.

The side flange portion 111 of the first end plate 110, which is one of the aforementioned flange portions, may be coupled to the first end 131 of the side plate 130. The side flange portion 111 is a portion to which the connection member, such as, for example, the side plate 130, is coupled so as to connect the first and second end plates 110 and 120 to each other. The first through-holes 111a may be provided to the first end plate 110, and the second through-holes 131 a respectively corresponding to the first through-holes 111a may be provided to the first end 131 of the side plate 130. The first and second through-holes 111a and 131a may be aligned with each other so as to be penetrated by the fixing member 20. Although the fixing member 20 may include, for example, a bolt, stud or the like, the embodiments are not limited thereto. That is, the first end plate 110 may be coupled to the side plate 130 using various methods including welding and the like.

When the first end plate 110 and the side plate 130 are connected to each other as described above, the first and second through-holes 111a and 131a may be provided to have a greater diameter than the fixing member 20 that penetrates the first and second through-holes 111a and 131a. If the fixing member 20 were to be provided to have a greater diameter than the first and second through-holes 111a and 131a, the fixing member 20 might not penetrate the first and second through-holes 111a and 131a. If the fixing member 20 were to be provided to have a diameter approximately identical to the first and second through-holes 111a and 131a, tolerance necessary for assembling may not be ensured in the manufacture of the battery module 100. Therefore, the manufacturing time and failure rate of products may be increased, and production cost may also be increased. Accordingly, the first and second through-holes 111a and 131a may be provided to have a greater diameter than the fixing member 20 in consideration of the assembling tolerance.

As described above, the first and second through-holes 111a and 131a may be provided to have a greater diameter than the fixing member 20. Therefore, when the first end plate 110 and the side plate 130 are fixed to each other, they may not be aligned with each other, and hence, the side plate 130 may not be fixed to the normal position of the first end plate 110. In a case where the sizes of the first and second through-holes 111a and 131a are provided to have opposite boundary values within error ranges, respectively, e.g., in a case where the first and second through-holes 111a and 131a are provided to have minimum and maximum diameters, respectively, the manufacturing process may be performed because the first and second through-holes 111a and 131a may not be considered to be failures. The shape of the battery module 100 manufactured accordingly may be deformed. That is, the position of each of the first end plate 110 and the side plate 130 may be deviated from the normal position, and furthermore, the fastening between the first end plate 110 and the side plate 130 by the fixing member 20 may be interrupted. Therefore, the fastening between the first end plate 110 and the side plate 130 may be loosened by external forces such as vibration.

The misalignment between the first end plate 110 and the side plate 130 may cause a failure of the external appearance of the battery module 100. Further, since the battery cells 10 are not stably fixed, the battery cells 10 may be excessively pressurized, or a space may be formed in which the battery cells 10 can move. In a case where the battery cells 10 are excessively pressurized, the flow of current may be interrupted in the charge or discharge of the battery cells 10. Therefore, the efficiency of the battery cells 10 may be deteriorated. In a case where a space is formed in which the battery cells 10 can move, the battery cells 10 may be moved by external forces, and hence, a problem may be caused in an electrical connection between the battery cells 10. Therefore, the battery module 100 may not be useful as a power source of external electronic devices.

Thus, in the manufacture of the battery module 100, it is desirable that the first end plate 110 and the side plate 130 should be coupled to their normal positions, respectively. Accordingly, the battery module 100 according to this embodiment may include the first and second alignment portions 160 and 170 so as to easily identify or indicate the alignment between the first end plate 110 and the side plate 130. In the assembling of the battery module 100, speed and accuracy can be enhanced by making use of the first and second alignment portions 160 and 170. While the battery module 100 is being used as a power source, it can be easily identified when the shape of the battery module 100 becomes deformed or that the first end plate 110 becomes deviated from the normal position. Thus, the battery module 100 can be easily maintained and repaired.

The side flange portion 111 provided to the first end plate 110 may be provided to have a wider area than the first end 131 of the side plate 130 coupled to the side flange portion 111. In this instance, the second alignment portion 170 is provided at a side end of the first end of the side plate 130, and may be provided at a position corresponding to the first alignment portion.

The battery module 100 may control the number and thickness of the battery cells 10 according to specifications of an electronic device using the battery module 100 as a power source, the thickness of the first end plate 110 or the side plate 130, and the like. Accordingly, the fastening position of each of the members may be predetermined. That is, the position at which the first end plate 110 and the side plate 130 are fastened to each other may be predetermined, and the first and second alignment portions 160 and 170 may be provided to correspond to each other at the predetermined position.

The first alignment portion 160 according to this embodiment may be provided parallel to the battery cell 10 in the length direction of the battery cell 10, and the second alignment portion 170 may be provided to extend in a straight line with respect to the first alignment portion 160. The first alignment portion 160 may be provided at the side flange portion 111 of the first end plate 110, and the second alignment portion 170 is provided at the first end 131 of the side plate 130. When the battery module 100 is manufactured, a correct alignment may be identified with the naked eye by observing whether the first and second alignment portions 160 and 170 are extended to each other in a straight line. Thus, as the battery module 100 can be easily manufactured, and it may be possible to decrease the failure rate of products and to improve the efficiency of a manufacturing process.

Although the first or second alignment portion 160 or 170 may be provided, for example, using laser or punching, the embodiments are not limited thereto. That is, the first or second alignment portion 160 or 170 may be appropriately modified according to the material of the first end plate 110 or the side plate 130, to which the first and second alignment portion 160 or 170 is provided.

Although the side flange portion 111 of the first end plate 110 and the first end 131 of the side plate 130 have been illustrated in FIGS. 3A and 3B, the embodiments are not limited thereto. That is, the aforementioned description may be similarly applied to the second end plate 120 and the second end 132 of the side plate 130 or the bottom plate 140, and the like.

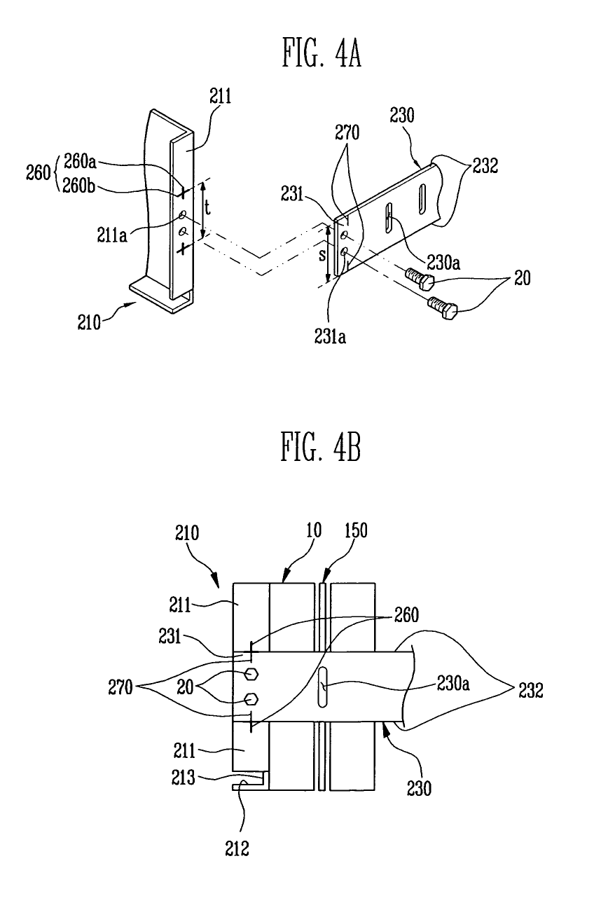

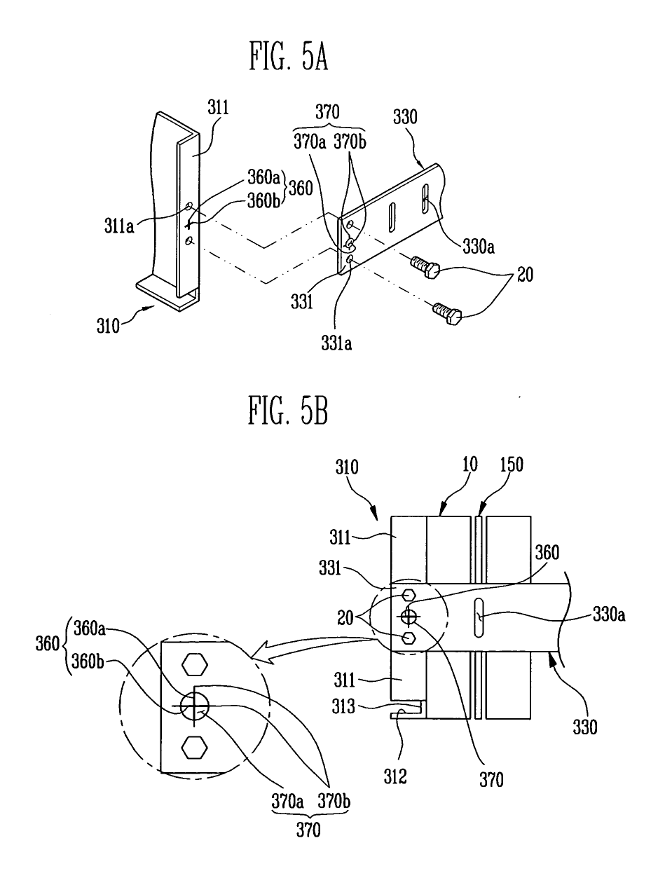

Hereinafter, another exemplary embodiment will be described with reference to FIGS. 4A to 5B. Since of the features shown in FIGS. 4A to 5B, are similar to those of FIGS. 1 to 3B, except for features that differ according to the following description, a detailed description of the similar features will not be repeated.

FIG. 4A is an exploded perspective view of a fixing portion of a first end plate and a side plate according to another embodiment. FIG. 4B is a side view showing a state in which the side plate is coupled to the first end plate.

Referring to FIGS. 4A and 4B, the battery module according to this embodiment includes a first end plate 210 provided with a side flange portion 211 and a side plate 230. The first or second end of the side plate 230 may be fixed to the side flange portion 211. The flange portion 211 may include one or more first alignment portions 260, and the first end of the side plate 230 may include a second alignment portion 270 provided to correspond to the first alignment portion 260.

The first alignment portion 260 may include a vertical portion 260a provided parallel in the length direction of the battery cell 10 and a horizontal portion 260b provided to intersect the vertical portion 260a. The second alignment portion 270 may be provided to extend in a straight line with respect to the vertical portion 260a. The horizontal portion 260b of the first alignment portion 260 may vertically intersect with the vertical portion 260a so as to correspond to a side end 232 of the side plate 230.

One or more first through-holes 211a and one or more second through-holes 231a may be provided to the flange portion 211 of the first end plate 210 and the first end 231 of the side plate 230, respectively. The first and second through-holes 211a and 231a are penetrated by the fixing member 20 so that the first end plate 210 and the side plate 230 can be fastened and fixedly coupled to each other. The first alignment portion 260 may further include the horizontal portion 260b so that the side plate 230 may be easily fixed at the normal position on the first end plate 210. The horizontal portion 260b may be provided to correspond to the side end 232 of the side plate 230, so that the alignment in the side direction of the side plate 230 can be easily identified with the naked eye.

The first alignment portions 260 may be provided at upper and lower sides with respect to the center of the side flange portion 211, respectively. The interval t between the horizontal portions 260b respectively provided at the upper and lower sides of the first alignment 260 may be provided to correspond to the minor-axis distance s between the side ends 232 of the side plate 230. The first and second alignment portions 260 and 270 according to this embodiment enable the alignment between the first end plate 210 and the side plate 230 to be more easily performed. Further, the existence of failure with respect to the minor-axis length s of the side plate 230 can be identified at one time, thereby improving process efficiency.

FIG. 5A is an exploded perspective view of a fixing portion of a first end plate and a side plate according to still another embodiment. FIG. 5B is a side view showing a state in which the side plate is coupled to the first end plate.

Referring to FIGS. 5A and 5B, the battery module according to this embodiment includes a first end plate 310 provided with a side flange portion 311 and a side plate 330. A first end 331 of the side plate 330 may be coupled to the side flange portion 311. The flange portion 311 may include two first through-holes 311a, and the first end 331 or the second end of the side plate 330 may include a second through-hole 331 a provided to corresponding to the first through-hole 311a. The first and second through-holes 311a and 331a may be coupled by the fixing member 20.

In this instance, the side flange portion 311 may include a cross-shaped first alignment portion 360 provided between the two first through-holes 311a. The first end 331 or second end of the side plate 330 may include a second alignment portion 370 corresponding to the first alignment portion 360. The second alignment portion 370 may include a hole 370a provided so that a cross-shaped center of the first alignment portion 360 and four line shapes 370b provided around the hole 370a may be oriented with respect to each other. The line shape 370b may be provided to extend in a straight line with respect to each end of the cross-shaped first alignment portion 360, exposed through the hole 370a.

The first alignment portion 360 may include a vertical portion 360a provided parallel in the length direction of the battery cells 10 and a horizontal portion 360b provided to intersect the vertical portion 360a. In this instance, the horizontal portion 360b may vertically intersect with the vertical portion 360a so as to be formed in a cross shape.

The center of the first alignment portion 360 formed in the cross shape may be exposed through the hole 370a of the second alignment portion 370. The four line shapes 370b provided around the hole 370a may extend in a straight line from the respective ends of the cross-shaped first alignment portion 360 when the first end plate 310 and the side plate are aligned, so that the first end plate 310 and the side plate 330 can be easily aligned with each other, for example, by visual inspection.

The first and second alignment portions 360 and 370 may be provided to the side flange portion 311 of the first end plate 310 and the first end 331 of the side plate 330, respectively. In the first and second alignment portions 360 and 370 according to this embodiment, only one alignment portion is provided to each of the flange portions, so that the first end plate 310 and the side plate 330 can be easily aligned with each other. Thus, since a plurality of alignment portions are not required, the number of processes necessary for producing the alignment portions can be decreased, thereby improving the production efficiency of the battery module.

In the aforementioned embodiments, the fixing portion between the first end plate and the side plate has been described. However, the embodiments are not limited thereto but may be similarly applied to various portions including the other members that constitute the battery module, e.g., the second end plate and the side plate, the first or second end plate and the bottom plate, and the like.

By way of summation and review, a battery cell may include an electrolyte and an electrode assembly having a positive plate and a negative electrode plate. The battery generates energy through an electrochemical reaction of these electrode plates and the electrolyte. In this instance, gas may be generated as a side reaction of the electrochemical reaction in the interior of the battery cell; and the generated gas may change the external shape of the battery cell. Further, the change in the external shape of the battery cell has influence on the shape of a battery module formed by aligning a plurality of battery cells. Therefore, the battery cells may not be firmly fixed in the battery module. Accordingly, various types of battery modules are developed so as to minimize a change in the external shape of battery cells and to enhance productivity of the battery modules.

Embodiments described herein may provide a battery module capable of enhancing reliability by improving the accuracy of assembling of battery cells in the manufacture of the battery module. Accordingly production efficiency may be enhanced. Embodiments also provide a battery module in which alignment between members that constitute the battery module may be easily performed, thereby reducing process failure.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope as set forth in the following claims.

What is claimed is:

1. A battery module comprising:
a plurality of battery cells aligned in one direction;
first and second end plates respectively disposed outside of end ones of the battery cells; and
one or more connection members that connect the first and second end plates to each other,
one or more first alignment portions on at least one side of the first and second end plates, and
one or more second alignment portions corresponding to the one or more first alignment portions on the one or more the connection members.

2. The battery module as claimed in claim 1, further comprising at least one fixing portion in co-operation with the first and second alignment portions,
wherein the fixing portion is connected to the first or second end plate and a first or second end of a connection member of the one of more connection members.

3. The battery module as claimed in claim 2, wherein the fixing portion includes a first through-hole through the first or second end plate, and a second through-hole through the first or second end of the connection member so as to correspond to the first through-hole.

4. The battery module as claimed in claim 3, wherein the first and second through-holes align with each other so as to be penetrated by a fixing member.

5. The battery module as claimed in claim 4, wherein the fixing member includes a bolt or stud.

6. The battery module as claimed in claim 1, wherein the first or second end plate includes a base plate disposed parallel to the battery cells, and one or more flange portions at side ends of the base plate, the one or more flange portions being bent in an opposite direction with respect to the battery cells.

7. The battery module as claimed in claim 6, wherein at least a portion of the flange portion contacts the first or second end of a connection member of the one or more connection members.

8. The battery module as claimed in claim 7, wherein the flange portion includes the one or more first alignment portions, and the first or second end of the connection member includes the one or more second alignment portions that correspond to the one or more first alignment portions.

9. The battery module as claimed in claim 7, wherein the flange portion is wider than the first or second end of the connection member coupled to the flange portion.

10. The battery module as claimed in claim 9, wherein the second alignment portion is provided at a side end of the first or second end of the connection member at a position corresponding to the first alignment portion.

11. The battery module as claimed in claim 10, wherein the first alignment portion is parallel to a length direction of the battery cells, and the second alignment portion extends in a straight line with respect to the first alignment portion.

12. The battery module as claimed in claim 10, wherein
the first alignment portion includes a vertical portion that is parallel to the battery cells in the length direction of the battery cells and a horizontal portion that intersects the vertical portion, and
the second alignment portion extends in a straight line with respect to the vertical portion.

13. The battery module as claimed in claim 12, wherein the horizontal portion of the first alignment portion vertically intersects with the vertical portion so as to correspond to a side end of the connection member.

14. The battery module as claimed in claim 7, wherein
the flange portion includes two first through-holes, the first or second end of the connection member includes two second through-holes that respectively correspond to the two first through holes, and
the first and second through-holes are coupled by a fixing member.

15. The battery module as claimed in claim 14, wherein
the one or more first alignment portions includes a cross-shaped first alignment portion on the flange portion and between the two second through-holes, and
the one or more second alignment portions includes:
a hole in the first or second end of the connection member such that a cross-shaped center of the first alignment portion is exposed, and
line shapes that respectively extend in a straight line with respect to each end of the cross-shaped center exposed through the hole.

16. The battery module as claimed in claim 1, wherein the first or second alignment portion is provided using a laser or by punching.

17. The battery module as claimed in claim 1, wherein the one or more connection members includes side plates that support sides of the battery cells and a bottom plate that supports bottom surfaces of the battery cells.

18. The battery module as claimed in claim 17, wherein the side plate includes side plate holes through which a coolant for cooling the plurality of battery cells passes.
